(19) United States
(12) Patent Application Publication
(10) Pub. No.: US 2010/0014867 A1
(43) Pub. Date: Jan. 21, 2010

(54) Enegy Converter Device and use Thereof in Remote Powering and/or Remote Control of Remotely-Sited Active Optical Components in an Optica Telecommunication Network

(76) Inventors: Hary Ramanitra, Antananarivo (MG); Philippe Chanclou, Lannion (FR); Jackie Etrillard, Locquemeau (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/991,582

(22) PCT Filed: Sep. 6, 2006
(86) PCT No.: PCT/FR2006/050848

§ 371 Date: Jun. 4, 2009

(51) Int. Cl. H04B 10/00

(52) U.S. Cl. 398/111; 398/106

(57) ABSTRACT

A module for converting light energy into electric energy (MC1) for use in an optical network to convert into electric energy light energy derived from an optical signal transported in an optical fiber (FTa₁) from a light energy source (OS1). The module can be used in remote powering and/or remote control devices for optical networks.

The present invention relates generally to a device for converting light energy into electrical energy and to its use in remote powering and/or in remote control of remotely-sited active optical components in an optical telecommunications network.

At present, telecommunications networks are divided into three parts: the core network, the metropolitan area network, and the access network. Recent developments suggest that optical fiber will become the preferred transmission medium of the access network, just as it is already for the core network and for the metropolitan area network. Optical fiber being the dominant transport medium in telecommunications networks, numerous optical functions such as splitting or switching, for example, are spread throughout said networks and the question of supplying electrical power to the optical components implementing these functions is at the heart of much thinking. Such optical components, referred to as active optical components, have at least one optical input and at least one optical output that are separate from each other, and they perform an optical function between the optical input(s) and the optical output(s). Extension of optical fiber to the access network can only accentuate this state of affairs.

There are at present two responses to these problems of supplying electrical power in optical networks: local powering and remote powering.

Local powering consists in placing a source of electrical energy in the vicinity of the active optical component(s) to be supplied with power. The energy source is usually a connection to an electricity distribution network. The various equipments for this, such as the transformer, the rectifier or DC-DC converter, and the back-up battery are stored in a cabinet installed at the roadside.

At locations where operating conditions are favorable, energy is supplied by an autonomous photovoltaic energy source that consists of a plurality of photovoltaic cells associated with a regulator and a storage battery. Correct operation of this kind of energy source depends on climatic conditions, which limits their geographical field of use.

Local powering of active optical components of the network has a number of drawbacks, in particular in terms of cost and wiring complexity. Complex wiring leads to a lack of reliability and dependence on an electricity distribution network results in a lack of flexibility in terms of the choice of the location of the optical components in the telecommunications network. Although the solution using an autonomous source offers greater freedom in terms of the distribution of active optical components in the network, it has drawbacks such as its high dependency on climatic conditions and high maintenance costs.

Remote powering over copper pairs has been proposed to alleviate the drawbacks of local powering.

That solution consists in conveying the electrical energy necessary for the operation of the active optical components via a copper pair from a remotely-sited energy source, which can be located in a telephone exchange, at the entry to the optical distribution area, or on subscriber premises. Depending on the location of the energy source, it can be backed up by a generator set serving as a standby source.

That powering technique has a number of drawbacks, however. A first drawback relates to the effect of parameters such as the electromagnetic environment or the relative humidity of the location in which the cables are run. For this reason it is necessary to protect them against electromagnetic waves, high and low voltages, and short-circuits between pairs. Such protection entails a significant cost.

A second drawback is the necessary presence near the active optical components to be powered of voltage converters and electronic control cards, which consume energy. The electrical voltage delivered by an electricity distribution network being 48 V, it must be reduced if it is to power an active optical component without damaging it because of an unsuitable electrical voltage.

Finally, a third drawback relates to the architecture of the optical access network. Remote powering is based on the principle that a copper pair for transporting energy runs alongside an optical fiber for transporting data. Because the access network is too dense, it is not feasible to associate an optical fiber with a copper pair.

An aim of the present invention is therefore to propose a solution for supplying electrical power to active optical components spread throughout an optical network that is free of the drawbacks of the prior art.

To this end, the invention provides a device for remote powering an optical component, which device is characterized in that it includes a passive energy converter module for converting light energy into electrical energy for powering said active optical component.

The device for supplying energy to the active optical components of the network uses either the optical fibers already present in the network or a dedicated fiber as the transport medium, and it obtains the energy necessary for operating the active optical components spread throughout said network by converting light energy conveyed in this way into electrical energy. The network is simplified by eliminating the copper pair used to transport the electrical energy.

In one particular embodiment of the invention, the energy converter module includes a photovoltaic component.

In one embodiment said device includes a passive circuit for amplifying an electrical parameter for amplifying the electrical power delivered to the output of the energy converter module.

This embodiment remote powers energy-consuming active optical components without having to use a large number of photovoltaic components in the energy converter module.

The invention also provides a device for remote control of an active optical component, which device is characterized in that it includes local power supply means connected to said active optical component, a passive energy converter module, and a switch adapted to be controlled by said energy converter module.

In one embodiment of the invention the energy converter module includes a photovoltaic component.

The electrical energy consumption of a telecommunications network equipped with such remote control devices, the cost of which is low, is significantly reduced. The remote control technique using an electricity distribution network employs active components with high energy consumption.

In another embodiment, the energy converter module and the switch device consist of a phototransistor.

This embodiment simplifies the optical telecommunications network, reduces its cost, and reduces the optical power necessary for said network to operate.

The invention further provides an optical network including an optical source, an active optical component to be remote powered, and an optical fiber for conveying light from the optical source to said active optical component, which network is characterized in that it includes an energy converter module including a photovoltaic component, said energy converter module converting light energy into electrical energy to power said active optical component.

In a network of this kind, energy is conveyed in a dielectric medium insensitive to the electromagnetic environment, i.e. the optical fiber. The invention therefore applies with particular advantage in fields where constraints linked to high magnetic fields give rise to problems of supplying electrical energy to certain active optical components.

The light energy can be conveyed by an optical fiber for transporting data or a fiber dedicated to remote powering.

The embodiment employing a data optical fiber is advantageous because it uses an existing medium and this represents a significant saving.

The invention further provides an optical network including an optical source, an active optical component to be remote powered, and an optical fiber for conveying light from the optical source to said active optical component, which network is characterized in that it includes an energy converter module including a photovoltaic component, said energy converter module converting light energy into electrical energy to power said active optical component.

Other features and advantages become apparent on reading the description of preferred embodiments with reference to the drawings, in which:

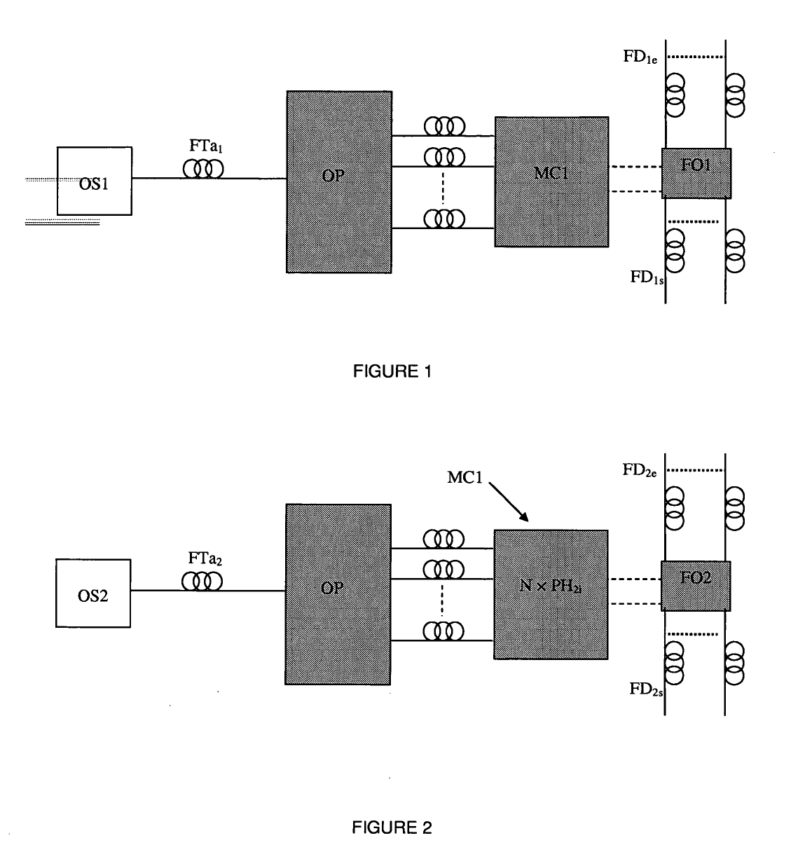

FIG. 1 represents a telecommunications network of the invention operating on the principle of a dedicated optical fiber illuminating an energy converter module for supplying an active optical component with electrical energy;

FIG. 2 represents a telecommunications network of the invention operating on the principle of a dedicated optical fiber illuminating an energy converter module consisting of N photovoltaic components;

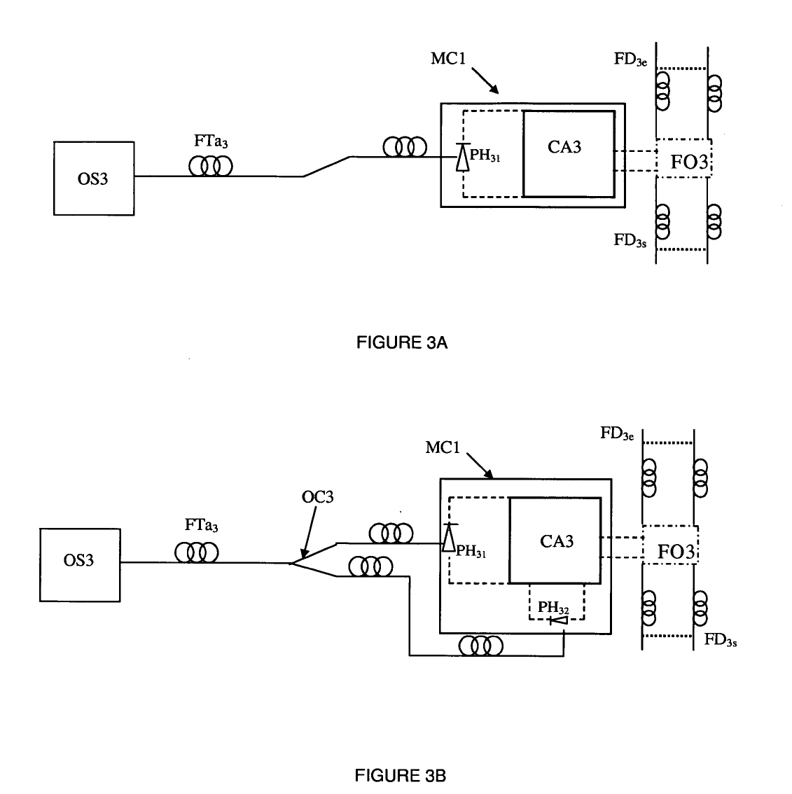

FIG. 3A represents a telecommunications network of the invention in which the energy converter module consists of a photovoltaic component connected to a passive electrical power amplifier circuit;

FIG. 3B represents a telecommunications network of the invention in which the energy converter module consists of two photovoltaic components connected to an active electrical power amplifier circuit;

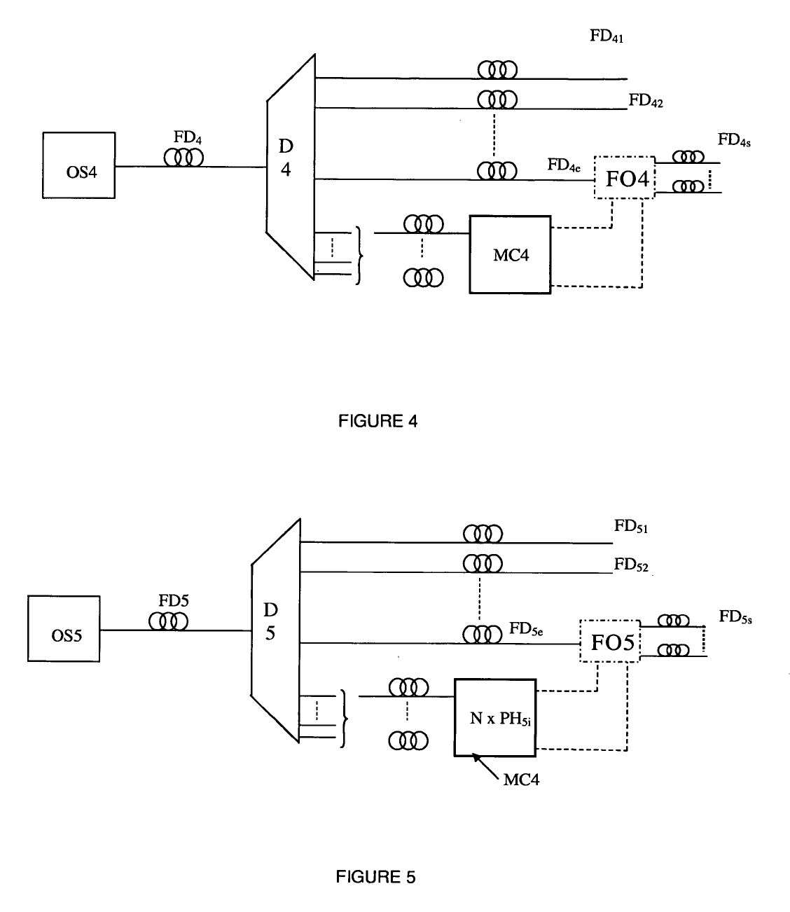

FIG. 4 represents a telecommunications network of the invention using a data optical fiber in which at least one optical channel is assigned to illuminating an energy converter module;

FIG. 5 represents a telecommunications network of the invention using a data optical fiber in which the energy converter module consists of a plurality of photovoltaic components;

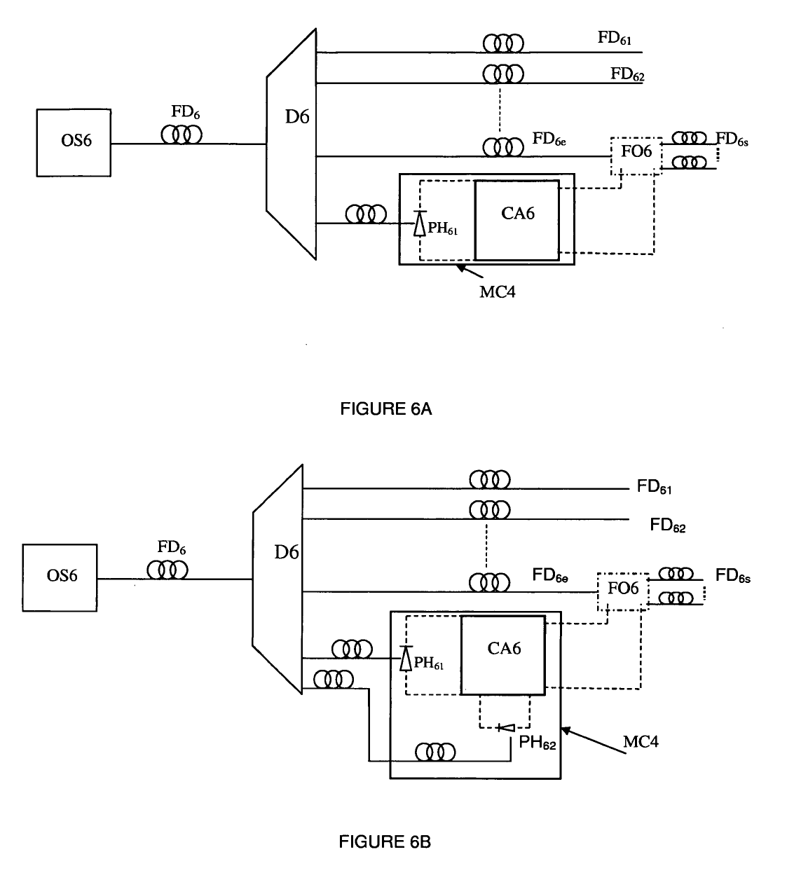

FIG. 6A represents a telecommunications network of the invention using a data optical fiber in which the energy converter module consists of a photovoltaic component connected to a passive electrical power amplifier circuit;

FIG. 6B represents a telecommunications network of the invention using a data optical fiber in which the energy converter module consists of a photovoltaic component connected to an active electrical power amplifier circuit;

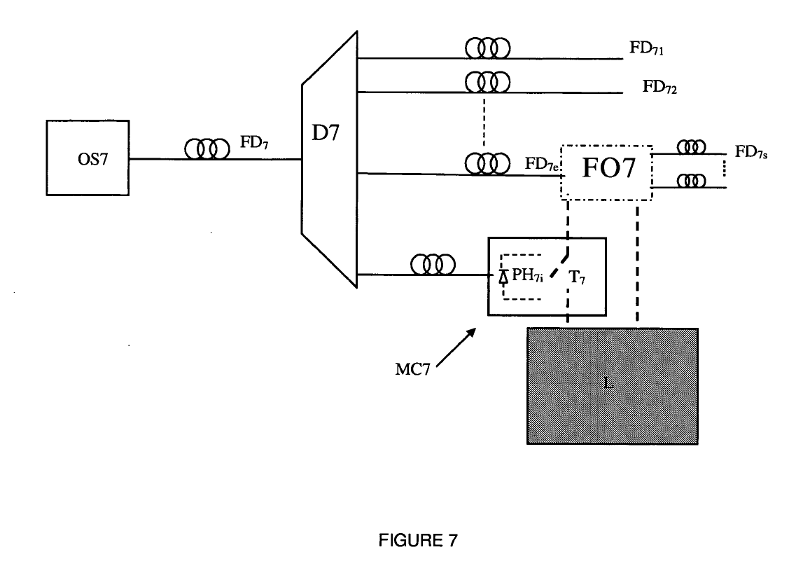

FIG. 7 represents a telecommunications network of the invention using a data optical fiber in which at least one optical channel is assigned to illuminating an energy converter module for controlling an active optical component.

In each of the figures, dashed lines represent electrical circuits and solid lines represent optical circuits.

Optical networks have optical functions that are implemented by active optical components with very low electrical power consumption, of the order of a few tens of milliwatts. This is one reason why optical networks lend themselves well to remote powering. Variable optical couplers are one example of such active optical components.

According to the invention, the light energy conveyed by optical fibers in the telecommunications network is converted into electrical energy. This conversion is effected by means of an energy converter module having the particular feature of being passive, i.e. of requiring no supply of electrical power to operate.

FIG. 1 is a general illustration of a telecommunications network in which the invention is implemented. In this network, light for supplying electrical power to an active optical component FO1 is transported in a dedicated optical fiber FTa₁. In other words, the optical fiber FTa₁ conveys only light for supplying electrical power to the active optical component FO1, and no data. Near the active optical component FO1 to be supplied with power, for example in the same storage unit, the dedicated fiber FTa₁ is connected to a passive optical component OP with one input and N outputs, where N corresponds to the number of inputs of an energy converter module MC1 to be illuminated. The number of inputs of the converter module MC1 to be illuminated depends on the energy requirements of the active optical component FO1 to be supplied with power. Thus the number N of inputs of the converter module MC1 varies according to the electrical power consumption of the active component FO1.

In this network, the “1 input to N output” device OP is a “1 to N” passive optical coupler, for example, or a wavelength demultiplexer. If the “1 to N” device is an optical coupler, each input of the converter module MC1 is connected to its own optical fiber and is illuminated by the same wavelength. If the “1 to N” device is a demultiplexer, each input of the converter module MC1 is illuminated by its own wavelength.

Finally, the energy converter module MC1 is electrically connected to the active optical component FO1 to be supplied with power.

The active optical component FO1 is connected to an optical fiber FD₁ₑ for routing incoming data to said optical component FO1 and to an outgoing optical fiber FD₁ₛ for distributing outgoing data as a function of its destination in the network. The number of incoming optical fibers FD₁ₑ and the number of outgoing optical fibers FD₁ₛ connected to the active optical component FO1 depend on the type of function it implements. For example, if the active optical component FO1 is a “1 to 2” variable optical coupler, it is connected to one incoming optical fiber and to two outgoing optical fibers.

The energy converter device MC1 is illuminated by an optical source OS1 via the dedicated optical fiber FTa₁. The optical source OS1 consists of a laser, an amplifier or a laser and an amplifier, for example. This optical source OS1 is located in the telephone exchange, for example, but could instead be located in an intermediate power feed station.

In an access network, data travels short distances. The optical power necessary to convey the data is therefore low. This level of optical power is insufficient for remote powering an active optical component, which is why the invention is applied to remote powering active optical components located in an access network, as applies to the particular embodiments of the invention represented in FIGS. 2 to 3B, the light for illuminating the converter module MC1 being conveyed by a dedicated optical fiber in which an appropriate optical power is sent.

Accordingly, the optical source OS1 is usually dedicated entirely to remote powering. It is then necessary to provide a second optical source (not shown in the figures) for sending data in the network. Nevertheless, in some circumstances, a single optical source is used both for remote powering and for sending data in the network.

FIG. 2 represents a first particular embodiment of the invention in which the energy converter module MC1 consists of a plurality of passive photovoltaic components PH₂ᵢ connected in series or in parallel to amplify the delivered voltage or current, respectively. The number of photovoltaic modules PH₂ᵢ to be illuminated depends on the energy requirements of the active optical component FO2 to be powered to which they are electrically connected. One such photovoltaic component is a photodiode, for example.

In a second particular embodiment of the invention represented in FIG. 3A, the device for powering an active optical component FO3 consists of a single photovoltaic component PH₃₁ connected to a dedicated optical fiber FTa₃. In this system, the optical power transported by the dedicated fiber FTa₃ is injected into the photovoltaic component PH₃₁ to which an amplifier circuit CA3 for amplifying the electrical power delivered by said photovoltaic component PH₃₁ is connected, the amplifier circuit CA3 preferably being a passive circuit. Finally, the amplifier circuit CA3 is connected to the active optical component FO3 to be powered in order to deliver the amplified electrical power to it and said passive optical component is also connected to an incoming optical fiber FD₃ₑ and an outgoing optical fiber FD₃ₛ.

The embodiment represented in FIG. 3B is a variant of the embodiment represented in FIG. 3A. It differs therefrom in that the amplifier circuit CA3 is an active circuit, i.e. one that requires a supply of electrical energy to operate, even if that means a very small quantity of electrical energy. It is then necessary to introduce a second photovoltaic component PH₃₂ into the electrical energy supply device. The function of this second photovoltaic component PH₃₂ is to supply the energy necessary for the amplifier circuit CA3 to operate. To this end, a “1 to 2” optical coupler OC3 for splitting light from the optical source OS3 between the two photovoltaic components PH₃₁ and PH₃₂ is provided at the end of the fiber FTa₃.

FIGS. 4, 5, 6A, and 6B show four other networks in which light for supplying electrical power to active optical components is transported in the same optical fiber as data. These systems are preferred for remote powering in long-haul networks, for example the core network, in which data is transported at a high optical power.

These systems are more economical because they use media already present in the network to convey light to the passive optical components to be powered.

Light for remote powering active optical components travels in the same optical fiber as data, the networks represented generically in FIG. 4 and more specifically in FIGS. 5, 6A, and 6B using a wavelength demultiplexer Dᵢ as a “1 to N” device. This kind of “1 to N” device is adapted to separate data from light for remote powering as a function of wavelength. In these systems, a data fiber FD4, FD5, FD6 reaches the input of a demultiplexer Dᵢ which extracts wavelength(s) for remote powering a nearby active optical component FO4, FO5, FO6.

In the context of the invention as represented generically in FIG. 4, once these wavelengths have been extracted, they are directed to an energy converter module MC4 electrically connected to the active optical component FO4 to be powered, which is itself connected to an optical fiber FD₄ₑ for conveying incoming data to said active optical component FO4 and to an outgoing optical fiber FD₄ₛ for distributing outgoing data as a function of its destination in the network.

In a first particular embodiment represented in FIG. 5, the energy converter module MC4 consists of a plurality of photovoltaic components PH₅ᵢ connected in series or in parallel to amplify the delivered voltage or current, respectively.

FIG. 6A represents a second particular embodiment in which the energy converter device MC4 consists of a single active optical component PH₆₁ connected to a passive amplifier circuit CA6 operating in the manner described above. FIG. 6B shows an active amplifier circuit CA6.

In a variant of the above embodiments that is not represented in the figures, the wavelengths for remote powering are supplied by an optical source separate from that for sending data. However, light from these two separate optical sources travels in the same data optical fibers.

In one advantageous embodiment of the invention, the energy for supplying electrical power to an optical component is also used to control it. This embodiment applies to remote control/remote powering of a variable optical coupler used for optical power distribution, for example.

A variable optical coupler is an active optical component for varying the percentage of light transmitted by each of its outputs from 0 to 100% and 100 to 0%, respectively. Among other things, such components split optical power as a function of the distance of users from the optical source, to favor one output over another, if required, or to recover optical power from a user subject to low optical losses in order to top up another user subject to higher optical losses.

The variation of the transmission ratio of the outputs of the optical coupler being a function of the current applied to its terminals, the output current of the power supply device used must be variable. For example, if the power supply device uses an energy converter module including a plurality of photovoltaic components, varying the optical power from an optical source for illuminating said photovoltaic components varies the electric current delivered to power the variable coupler and the optical coupler is therefore simultaneously controlled by the same means that power it. Thus the active optical component is controlled by varying the optical power of the sending optical source located in a remote telephone exchange.

The invention also applies to remote controlling active optical components independently of supplying power to said passive optical components. Remote control of active optical components does not require sending high optical powers in the network, which is why light for remote controlling active optical components is advantageously transported in optical fibers for transporting data.

One example of a network in which an active optical component is remote controlled in accordance with the invention is described next with reference to FIG. 7.

In the FIG. 7 network, the wavelength(s) dedicated to remote control travel in a data fiber FD₇ and are then separated from the data wavelengths by a demultiplexer D₇ in the vicinity of an active optical component FO7 to be controlled, said active optical component FO7 being connected to an data optical fiber FD₇ₑ for conveying incoming data to said active optical component FO7 and to an outgoing optical fiber FD₇ₛ for distributing outgoing data as a function of its destination in the network.

In this network, the remote control wavelength(s) are injected into an energy converter module MC7 that consists of a photovoltaic component PH₇ᵢ, for example. An electrical power supply is provided by a local energy source L if this is necessary for the active optical component FO7 that is to be remote controlled to operate. The local energy source L consists of lithium batteries, for example, or an outdoor panel of photovoltaic cells associated with a rechargeable battery. Finally, the power supply circuit is closed or opened by a switch T operated by the energy converter module MC7.

Accordingly, the illumination status of the energy converter module MC7 controls the active optical component FO7. In one embodiment of the invention that is not shown in the figures, the switch T consists of a transistor.

In a different embodiment that is also not shown in the figures, the transistor and the energy converter module MC7 are replaced by a phototransistor that functions both as an energy converter and as a switch.

The device described here has the advantage of not using an electricity distribution network and of having no energy-consuming component between the local energy source and the optical function to be controlled.

One example of the use of a remote control device of the invention is protecting or restoring an optical path. The network is protected by duplicating the main optical highway connecting the telephone exchange to the distribution point (for example). A failure at this level deprives all users of data. This type of protection uses “1 to 2” and “2 to 1” switches to switch instantaneously to the protection medium.

To switch transmission from one output to the other, it suffices to apply an electric voltage to the terminals of an optical switch for a very short time period, of the order of a few hundred nanoseconds. It is necessary to apply the same voltage with the opposite polarity to switch transmission back to the first output. Once transmission has been switched, it is no longer necessary to power the optical component to maintain this state, the switch having to be powered only during switching: it is referred to as “bistable”.

Although an optical switch does not need to be powered continuously, it requires a relatively high electrical power to activate it. Nevertheless, as it requires only a very small quantity of electrical energy, it can be powered by a lithium battery, which can have a service life of up to around ten years given the frequency of use of optical switches in an optical connection.

In another example of the use of the remote control device of the invention, the optical source OS7 disposed at the optical exchange and whose function is to transmit the remote control wavelength is an optical time domain reflectometer (OTDR). Using an optical reflectometer as the source of the remote control wavelength has many benefits, from the economic point of view among others. Reflectometers are light sources already present in the network, in which, by a technique known as reflectometry, they determine if an optical fiber of the network is subject to a fault or a break that could lead to poor transmission of data. This kind of assessment of the integrity of the optical fibers constituting the network is carried out regularly, for example every three hours, and takes a few minutes. This kind of reflectometer can therefore be used for other purposes the rest of the time.

Other bistable optical components can also be remote controlled by means of a device of the invention. Such components include variable optical attenuators (VOA) whose function is to equalize the optical power associated with each optical data signal sent by the network terminal equipment, for example from user equipments to the optical exchange. The optical power associated with each of the data optical signals varies as a function of the distances of the various user equipments from the optical exchange, which interferes with reception of these signals by the optical exchange.

Applying electrical power to a VOA for a short time period makes it possible to vary its attenuation level. This variation of the attenuation level is proportional to the electrical power applied to the VOA.

Although particular embodiments of the present invention have been described above, the person skilled in the art will understand that various modifications and adaptations can be made to the present invention without departing from the scope of the present invention.

1.-10. (canceled)

11. A remote control device for remote control of an active optical component (FOi), wherein the device comprises:
means for connection to one end of an optical fiber (FDᵢ, FTaᵢ) for transporting light energy; and
a passive energy converter module (MC7) for converting light energy into electrical energy for controlling the active optical component (FOᵢ).

12. The remote control device according to claim 11, comprising electrical power supply means (L) connected to the active optical component (FOᵢ)

13. The remote control device according to claim 12, comprising a switch device (T) connecting the local electrical power supply means (L) to the passive optical component (FOᵢ), said switch device (T) being actuated by the converter module (MC7).

14. A remote control device according to claim 13, wherein the energy converter module (MC7) and the switch device (T) consist of a phototransistor.

15. An optical network including an optical source (OSᵢ), an active optical component (FOᵢ), and an optical fiber (FDᵢ, FTaᵢ) for transporting light energy from the optical source (OSᵢ) to said active optical component (FOᵢ), and a device for remote control of said active optical component (FOᵢ), wherein the device comprises:
means for connection to one end of said optical fiber (FDᵢ, FTaᵢ); and
a passive energy converter module (MC7) for converting light energy into electrical energy for controlling said active optical component (FOᵢ).

16. The optical network according to claim 15, wherein the light energy for controlling said active optical component (FOᵢ) is transported by an optical fiber (FDᵢ) for transporting data.
